(19) United States
(12) Patent Application Publication
(10) Pub. No.: US 2005/0261890 A1
(43) Pub. Date: Nov. 24, 2005

(54) Method and apparatus for providing language translation

(76) Inventor: Sterling Robinson, New York, NY (US)

Correspondence Address: JENNIFER MEREDITH;MEREDITH & KEYHANI, PLLC, 330 MADISON AVE., 6TH FLOOR, NEW YORK, NY, 10017, US

(21) Appl. No.: 11/098,996

(22) Filed: Apr. 5, 2005

Related U.S. Application Data
(60) Provisional application No. 60/574,012, filed on May 21, 2004.

(51) Int. Cl. G06F 17/28

(52) U.S. Cl. 704/9

(57) ABSTRACT

A method and apparatus for enabling communication between a first user and a second user speaking different natural languages, comprising the steps of: providing a first apparatus; initiating a conversation between a first user and a second user speaking different languages; capturing a first audio file from a first user speaking a first language; transmitting the first audio file to the language translation software; translating the first audio file to a second language using the language translation software to provide a first audio file translation; and returning the first audio file translation to the first user through the output of translator device such that the first audio file translation is only audible to the first user.

This application claims priority to provisional application No. 60/574,012 filed May 21, 2004 entitled “Hand held Portable Foreign Language Translator.”

The present invention relates generally to a foreign language translator, and in particular to a method and apparatus for providing foreign language translations in a hand held, portable environment.

With the onset of the global economy, people have found it more and more necessary to interact with persons who speak a different language. This is becoming as common place in everyday life as it is in the business community. As corporations continue to outsource business functions to foreign lands, the likelihood of interacting with a person who does not speak the same language is increasing. Specifically, a number of customer service functions have been moved to non-English speaking countries.

Translation functions have traditionally been performed by human interpreters. Interpreters are primarily a benefit to businesses, not individuals. Even for business use, this process can be inefficient and cost prohibitive. Translators have to be scheduled in advance, so their necessity must be anticipated. This encumbers a business' ability to perform in today's fast moving economy.

In response, automatic translation services have been developed. Various internet sites offer online translation services. One common internet location is AltaVista's™ Babel Fish. Additionally, there has been an onset of voice recognition software that work in a client/server environment. While these services allow for immediate translation and are available on demand, there is still a need to have a computer with network access to utilize them. Because of this, they are not useful for tourists or business persons while traveling or in meetings.

U.S. Pat. No. 5,987,401 discloses language translation for real-time text-based conversations. This invention relies on a computer implemented method which requires a series of networked computers. The disclosed invention is not suitable for travelers, as it requires a computer with network access to a central server. Although a portable computer may be utilized, even they are typically oversized and cumbersome to carry. Furthermore, the invention is designed for text-based conversations in an on-line chatting format. There is no use disclosed for a real-time, in person conversation.

U.S. Pat. No. 6,438,524 discloses a method and apparatus for a voice controlled foreign language translation device. The invention of '524 accepts a voice input phrase, translates it into a second language, and outputs it in either audio or text format. The invention, however, relies on pre-programmed phrases. This limits the usefulness of the design to the confines of the phrases that were originally programmed, which may not pertain to all possible communication subjects.

U.S. Pat. No. 6,385,586 teaches a speech recognition based language conversion translation device. The invention discloses an easily transportable language translator that accepts speech input of a language, translates it into a second language, and outputs the result in both speech and text. The invention requires connecting to a remote server for the translation function, and does not provide additional functionality that is required in today's global business economy.

While prior art has cured some of the above mentioned defects, there still remains a need for a language translation device that is multi-functional, portable and internet capable, which is small enough for a traveler to carry with them on a personal vacation, yet versatile enough to be used by an international business person.

### SUMMARY OF THE INVENTION

The present invention related generally to translation methods and devices and more particularly to a method and device that both enables translation and communication between at least two individuals and may act as a foreign language tutorial device.

According to one embodiment, a method of enabling communication between a first user and a second user speaking different natural languages is disclosed, comprising the steps of: providing a first apparatus for a first user having an input and an output, transmission means, speech recognition software and language translation software; providing a second apparatus for a second user having an input, an output, transmission means, speech recognition software and language translation software; initiating a conversation between a first user speaking a first natural language and a second user speaking a second natural language; capturing a first audio file from a first user speaking a first language into the input using speech recognition software; transmitting the first audio file to language translation software; translating the first audio file to a second language using language translation software to provide a first audio file translation; and transmitting the first audio file translation to a second apparatus through a transmission means, such that the first audio file translation is audible to the second user.

A method of enabling communication between a first user and a second user speaking different natural languages, comprising the steps of: providing a first apparatus having an input, output, transmission means, speech recognition software and language translation software; initiating a conversation between a first user speaking a first natural language and second user speaking a second natural language; capturing a first audio file from a first user speaking a first language into the input using speech recognition software, wherein the first audio file is not audible to the second user; transmitting the first audio file to the language translation software; translating the first audio file to a second language using the language translation software to provide a first audio file translation; and returning the first audio file translation to the first user through the output of the translator device such that the first audio file translation is only audible to the first user.

A method of enabling communication between a first user and a second user speaking different natural languages, comprising the steps of: providing a apparatus having an input and an output; providing speech recognition software, the speech recognition software being in communication with the apparatus; providing language translation software in communication with the speech recognition software and the apparatus; initiating a phone conversation between a first user speaking a first natural language and second user speaking a second natural language; capturing a first audio file from a first user speaking a first language into the input using the speech recognition software, wherein the first audio file is not audible to the second user; transmitting the first audio file to the language translation software; translating the first audio file to a second language using the language translation software to provide a first audio file translation; and returning the first audio file translation to the second user through the apparatus, the first audio file translation being audible to the first user and the second user.

An apparatus for translating a conversation between a first user and a second user speaking different natural languages, the apparatus comprising: an input device for receiving an audio file from a first user speaking a first language; a storage medium for storing speech recognition software and language translation software; a CPU for processing language data from the input using the speech recognition software and the language translation software; a communication interface for connecting to the speech recognition software and the language translation software; and an output device for delivering audio files.

A pair of apparatus for translating a conversation between a first user and a second user speaking different natural languages, the apparatus comprising: a first device comprising: a microphone for receiving an audio file from a first user speaking a first language; a storage medium for storing supporting applications, wherein the supporting applications translate the audio from a first user speaking a first language to a second; a CPU for processing the language data; a second device comprising: an input device for receiving an audio file from a second user speaking a second language; an output device for delivering the audio second audio file translation; a communication interface for connecting to remote computer applications, the remote computer application comprising speech recognition software and language translation software.

This summary is not to be taken in a limiting sense, but is made merely for the purpose of illustrating the general principles of the invention, since the scope of the invention is best defined by the appended claims.

### BRIEF DESCRIPTION OF THE DRAWINGS

FIG. 1 depicts an apparatus according to the present invention;

FIG. 2 depicts a pair of apparatus according to the present invention; and

FIG. 3 depicts an apparatus according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

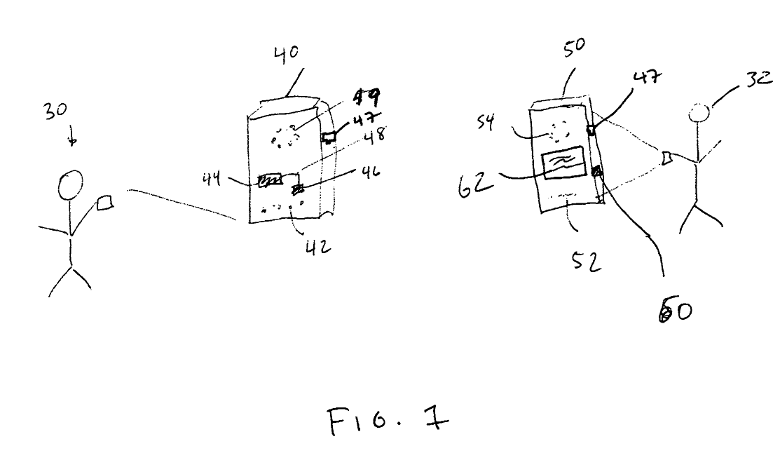

FIG. 1 depicts an apparatus for translating a conversation between a first user 10 and a second user 20 speaking different natural languages, or providing a translation from another person or television, the apparatus 12 comprising: an input device 11 for receiving an audio file from a first user 10 (which may be a television speaker) speaking a first language. The input device as shown is a microphone. However, it is also envisioned that the input device may be a keyboard, numeric text key pad, USB, television output, chat keyboard and video camera. A storage medium 14 is also disclosed for storing speech recognition software and language translation software; a CPU 16 for processing language data from the input using the speech recognition software and the language translation software; a communication interface 18 for connecting to the speech recognition software and the language translation software; and an output device 20 for delivering audio files. As shown, the storage medium 14 may be contained within the apparatus. However, it is also envisioned that the storage medium may be external. For example, all speech recognition software and language translation software may be stored on a remote computer which is in communication with the apparatus. In this instance, the CPU may also be contained within the apparatus or external. The communication interface 18 may also be internal or, for example, by a USB port 19 with a USB cord connecting the apparatus 12 to a computer. Or a telephone jack 47 which plugs directly into the device and the wall jack. According to the example shown, the first user 10 may be using a translator device and the second user 20 may simply be talking on a standard cellphone 22 or ground phone. The first user would, for example, press a directional key on the device to highlight language on a screen 21. Among the functions on the screen 21 would be a list of languages the user may chose to translate from and to. Then the user would select the language and press okay. For example, the first user may select “From: English To: French.”

It is also envisioned, that the screen 21 may also act as an output device. For example, the translation may only be provided on the screen 21 and the user would then read the translation aloud. According to this embodiment, the first user 10 may speak, but this is not audible to the second user 20. Then a translation is provided on the screen 21 and the first user 10 may speak the translation which is then audible to the second user 20. In this manner, the second user 20 is not aware that the first user 10 is using a translation device. This may be very useful for business calls, when it is useful for the person to whom you are speaking to believe that you at least have some basic understanding of their language. This may be accomplished by either an automatic pause and translation, or pressing a button during the period in which the user does not wish to be heard by the other party. The output device may also display the time, date and temperature, for example, with a picture of the weather condition (e.g. a sunshine).

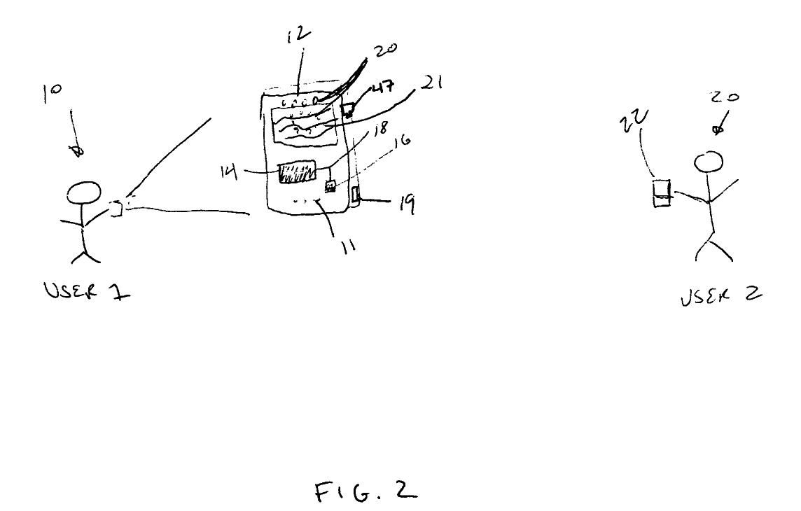

According to yet another embodiment, as depicted in FIG. 2, a pair of apparatus (40, 50) for translating a conversation between a first user 30 and a second user 32 speaking different natural languages is disclosed. The pair of apparatus comprising: a first device 40 with a microphone 42 for receiving an audio file from a first user 30 speaking a first language; a storage medium 44 for storing supporting applications, wherein the supporting applications translate the audio from a first user speaking a first language to a second; a CPU 46 for processing the language data; a second device 50 comprising: an input device 52 for receiving an audio file from a second user speaking a second language; an output device 54 for delivering a first translation to the second user 32; a communication interface 60 for connecting to remote computer applications, the remote computer application comprising speech recognition software and language translation software. The second device 50 may be a small clip on device that is in communication with the first device. It is envisioned that the first device, having a screen and inputs (e.g. a keyboard) would control the languages and have the majority of the functionality on board, whereas the second device would be a small clip-on device having an microphone input and an speaker only. As before, the communication interface 60 may be a USB or other port, may be wireless technology or any other method of communication known within the art. One purpose of the present invention is to allow a first user 30 speaking a first language to communicate with a second user 32 speaking a second language. The apparatus (e.g. 40, 50) allow for different ways to accomplish this task. The first is an automatic function, wherein the first user 30 speaks into the input device 42 and the supporting applications translate a first audio file from the first user to the second users language and communicates this directly to the second user, who may then speak back. The second device 50 allows for translation of a second audio file and delivers the second translation to the first user 30. There may also be, on either device, a screen 62 which provides a text transcript of the conversation, including both languages and there translation. For example, a text transcript may goes as follows:

USER1: Hello
TRANSLATION: Bonjour
USER2: Bonjour
TRADUCTION: Hello
USER1: How are you?
TRANSLATION: Comment allez vous?

In this manner, the first user and the second user may also learn the language. In this example, the first user (30) speaks English and the second user (32) speaks French. However, by reviewing the transcript, the first user (30) may learn to understand French and the second user 32 may learn to understand English.

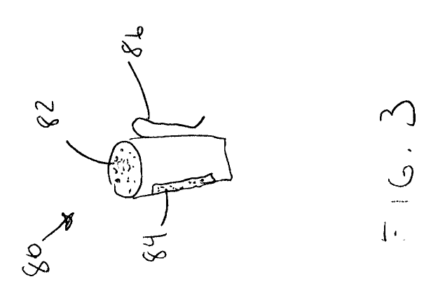

FIG. 3 depicts another embodiment of a second device 80 according to the present invention. As shown, the device has an input 82 which is a microphone, an output 84 that is a speaker and a clip 86 for attaching the second device 80 to the second user. It is intended that the second device 80 would be sold with the first device 40 as a package and contained within the second device 80 and the first device 40 would be a communication means for delivering a translation between the first user and the second user. This may be, for example, a simple radio transmitter similar to that of walkie-talkie. Or, it may be more complicated, for example similar to cell phone technology.

The present invention also provides a method of enabling communication between a first user and a second user speaking different natural languages, comprising the steps of: providing a first apparatus (12) for a first user (10) having an input 11 and an output 12, transmission means, speech recognition software and language translation software. The apparatus 12 may be a voice over internet protocol telephone device or a mobile telephone. The next step may be providing a second apparatus 22 for a second user having an input, an output, transmission means, speech recognition software and language translation software. However, the second apparatus may also be a standard telephone. It is envisioned that one user may be using a translator apparatus according to the present invention, and a second user may merely be talking on a standard cell phone. The input may be a microphone 11, keyboard, numeric text key pad, USB, television output, video camera or chat keyboard. The output may be a speaker 12, a earphone and/or a screen. The speech recognition and language translation software in each of the embodiments claimed and disclosed herein may be installed remotely or directly into the device and have communication with the apparatus. The next step is initiating a conversation between the first user 10 speaking a first natural language and the second user 20 speaking a second natural language, then capturing a first audio file from the first user 10 speaking a first language into the input using the speech recognition software, then converting the first audio file to text to provide a first text file, transmitting the first audio file to the language translation software, translating the first audio file to a second language using the language translation software to provide a first audio file translation; and transmitting the first audio file translation to the second apparatus through the transmission means, such that the first audio file translation is audible to the second user. This describes the automatic translation method. In this manner, the conversation that the second user hears may be first in English, then a translation. Or, alternatively, they may only hear the translation, which would likely be an automated type of voice translation. However, it may also be a staffed human translation by a third party vendor.

It is envisioned that the present invention would allow for a conversation between a first user and a second user, the second user would likely respond to the first user and as such, the next step may be capturing a second audio file from the second user speaking a second language into an input on a second device. There may be the steps of transmitting the second audio file to language translation software; translating the second audio file to a first language using language translation software to provide a second audio file translation; and transmitting the second audio file translation to the first user through a transmission means such that the second audio file translation is audible to the first user. There may also be a third apparatus and a third user, in which case the method would comprise the step of providing a third apparatus for a third user having an input and an output, transmission means, speech recognition software and language translation software; capturing a third audio file from a third user speaking a third language into an input; transmitting the third audio file to the language translation software; translating the third audio file to a first language and a second language using language translation software to provide a third audio file translation in the first users language and a third audio file translation in the second users language; and transmitting the third audio file translation in the first users language to the first user and the third audio file translation in the second users language to the second user. In this instance of a third user, the language from a first user and a second user speaking a first language and second language into an input must also be transmitted to the language translation software and translated into the third language. It is sent to the third user through the output.

According to another embodiment, a method of enabling communication between a first user and a second user speaking different natural languages is disclosed, comprising the steps of: providing a first apparatus having an input, output, transmission means, speech recognition software and language translation software; initiating a conversation between a first user speaking a first natural language and second user speaking a second natural language; capturing a first audio file from a first user speaking a first language into the input using speech recognition software, wherein the first audio file is not audible to a second user; transmitting the first audio file to language translation software; translating the first audio file to a second language using language translation software to provide a first audio file translation; and returning the first audio file translation to the first user through the output of the translator device such that the first audio file translation is only audible to the first user. The next step may be accepting a reading of the first audio file translation through an input device from the first user, the reading being audible to the second user. The next step of converting the first audio file to text to provide a first text file and transmitting the first text file to the language translation software. The step of providing a second apparatus having an input, output, transmission means, speech recognition software and language translation software; capturing a second audio file, wherein the second audio file is from a second user speaking a second language into an input and the second audio file is not audible to the first user. The step of transmitting the second audio file to the language translation software. The step of translating the second audio file to the first language using the language translation software to provide a second audio file translation; and the step of returning the second audio file translation to the second user through the output of the translator device such that the second audio file translation is only audible to the second user. As before, the speech recognition software may be installed remotely or directly into the device and have communication with the apparatus.

The method may further comprise the steps of: providing a second apparatus for the second user having an input and an output, speech recognition software and language translation software; initiating a conversation between a first user speaking a first natural language and second user speaking a second natural language; capturing a second audio file from a second user speaking a second language into the input using the speech recognition software; transmitting a second audio file to language translation software; translating the second audio file to a second language using the language translation software to provide a second audio file translation; and returning the second audio file translation to the first user through the output of the translator device.

A method of enabling communication between a first user and a second user speaking different natural languages, comprising the steps of: providing a apparatus having an input and an output; providing speech recognition software, the speech recognition software being in communication with the apparatus; providing language translation software in communication with the speech recognition software and apparatus; initiating a phone conversation between a first user speaking a first natural language and second user speaking a second natural language; capturing a first audio file from a first user speaking a first language into the input using the speech recognition software, wherein the first audio file is not audible to the second user; transmitting the first audio file to the language translation software; translating the first audio file to a second language using the language translation software to provide a first audio file translation; and returning the first audio file translation to the second user through the apparatus, the first audio file translation being audible to the first user and the second user. This method may further comprise the step of accepting a reading of the first audio file translation through the input device from the first user, the reading being audible to the second user. The method may further comprise the step of converting the first audio file to text to provide a first text file and transmitting the first text file to the language translation software. Also, capturing a second audio file using the speech recognition software, wherein the second audio file is from a second user speaking a second language into an input and the second audio file is not audible to the first user; transmitting the second audio file to the language translation software; translating the second audio file to the first language using the language translation software to provide a second audio file translation; and returning the second audio file translation to the second user through the output of the translator device such that the second audio file translation is only audible to the second user. This method may further comprise the step of providing a text-based chatting utility. As always, the language translation software may be installed remotely or directly into the device and have communication with the apparatus.

The apparatus may also be connected to a computer and the computer connected to the Television. The television would then effectively be the second user and the translation may appear for the first user either as a text caption on the first device or as an audible translation coming from the first device. The translation may also be viewable on the television screen similar to closed captioning. The apparatus may also be in communication with either a television or computer. In the event the apparatus is in communication with a computer, movies may be downloaded or transferred from the internet and transmitted to the device. The method may comprise the step of recording digital videos and movies from another device (such as a computer and television). By way of example, the apparatus may have a nano/micro motherboard with a sound and video card(s) or sounds and video chip set(s) that is connected to the micro DVD drive. The chipset(s) may act as a sound and video card(s) and may use a portion of the main system memory as video and movie memory (unified memory architecture). The chip set(s) may also include 3D accelerated video and audio support. The nano/micro motherboard may be connected to the apparatus' screen to transmit videos and movies downloaded or transferred through it from the internet and recorded from the television. The micro DVD drive as connected to the nano/micro motherboard may act similar to TiVo. The micro DVD drive may also accept a micro HD DVD R or Advanced Optical Disk (AOD) for storage or as a medium for recording and downloading movie and video content from the internet and television.

When the user of the device chooses to activate the Digital Video Recording (DVR) aspect of the device, press menu and a drop down menu will appear. One of the functionalities will be DVR, highlight and press OK. This will bring another drop down menu on to the screen which will give two selections television recording and internet downloading, chose one by highlighting it with the directional arrow keys and press OK. This will commence the recording or downloading of whatever medium programming is desired. Furthermore, once the desired program is recorded or downloaded a user of the apparatus will also be able to chose whatever language text caption or audible translation will narrate the movie or video. This functionality will also use a drop down menu interface which will act similar to the previous drop down menus mentioned, but it will be tailored to act in accordance with the content downloaded, recorded or played on the device.

It should be understood, of course, that the foregoing relates to preferred embodiments of the invention and that modifications may be made without departing from the spirit and scope of the invention as set forth in the following claims.

1. A method of enabling communication between a first user and a second user speaking different natural languages, comprising the steps of:
providing a first apparatus for a first user having an input and an output, transmission means, speech recognition software and language translation software;
providing a second apparatus for a second user having an input, an output, transmission means, speech recognition software and language translation software;
initiating a conversation between said first user speaking a first natural language and said second user speaking a second natural language;
capturing a first audio file from said first user speaking a first language into said input using said speech recognition software;
transmitting said first audio file to said language translation software;
translating said first audio file to a second language using said language translation software to provide a first audio file translation; and
transmitting said first audio file translation to said second apparatus through said transmission means, such that said first audio file translation is audible to said second user.

2. A method as in claim 1, further comprising the step of converting said first audio file to text to provide a first text file.

3. The method of claim 1, wherein said input is selected from a group consisting of microphone, keyboard, numeric text key pad, USB, television output, video camera and chat keyboard.

4. The method of claim 1, wherein said output is selected from the group consisting of a speaker, USB, earphone and a screen.

5. The method as in claim 1, further comprising the steps of:
capturing a second audio file from said second user speaking a second language into said input;
transmitting said second audio file to said language translation software;
translating said second audio file to said first language using said language translation software to provide a second audio file translation; and
transmitting said second audio file translation to said first user through said transmission means such that said second audio file translation is audible to said first user.

6. The method as in claim 5, further comprising the steps of:
providing a third apparatus for a third user having an input and an output, transmission means, speech recognition software and language translation software;
capturing a third audio file from said third user speaking a third language into said input;
transmitting said third audio file to said language translation software;
translating said third audio file to said first language and said second language using said language translation software to provide a third audio file translation in said first users language and a third audio file translation in said second users language; and
transmitting said third audio file translation in said first users language to said first user and said third audio file translation in said second users language to said second user.

7. The method of claim 1, wherein apparatus is a voice over internet protocol telephone device.

8. The method as in claim 1, wherein said apparatus is a mobile telephone.

9. The method as in claim 1, further comprising a text transcript on said apparatus.

10. The method as in claim 1, wherein said speech recognition software is installed remotely and in communication with said apparatus.

11. The method as in claim 1, further comprising the step of recording digital video from another device.

12. A method of enabling communication between a first user and a second user speaking different natural languages, comprising the steps of:
providing a first apparatus having an input, output, transmission means, speech recognition software and language translation software;
initiating a conversation between a first user speaking a first natural language and second user speaking a second natural language;
capturing a first audio file from a first user speaking a first language into said input using said speech recognition software, wherein said first audio file is not audible to said second user;
transmitting said first audio file to said language translation software;
translating said first audio file to a second language using said language translation software to provide a first audio file translation; and
returning said first audio file translation to said first user through said output of said translator device such that said first audio file translation is only audible to said first user.

13. The method of claim 12, further comprising the step of accepting a reading of said first audio file translation through said input device from said first user, said reading being audible to said second user.

14. A method as in claim 12, further comprising the step of converting said first audio file to text to provide a first text file and transmitting said first text file to said language translation software.

15. The method as in claim 1, further comprising the step of recording digital video from another device.

16. The method of claim 12, wherein said input is selected from a group consisting of microphone, keyboard, numeric text key pad, USB, television output, video camera and chat keyboard.

17. The method of claim 12, wherein said output is selected from the group consisting of a speaker, earphone and a screen.

18. The method as in claim 12, further comprising the steps of:
providing a second apparatus having an input, output, transmission means, speech recognition software and language translation software;
capturing a second audio file, wherein said second audio file is from a second user speaking a second language into an input and said second audio file is not audible to said first user;
transmitting said second audio file to said language translation software;
translating said second audio file to said first language using said language translation software to provide a second audio file translation; and
returning said second audio file translation to said second user through said output of said translator device such that said second audio file translation is only audible to said second user.

19. The method of claim 12, wherein apparatus is a voice over internet protocol telephone device.

20. The method as in claim 12, wherein said apparatus is a mobile telephone.

21. The method as in claim 12, further comprising a text transcript on said apparatus.

22. The method as in claim 12, wherein said speech recognition software is installed remotely and in communication with said apparatus.

23. The method as in claim 12, further comprising the steps of:
providing a second apparatus for said second user having an input and an output, speech recognition software and language translation software;
initiating a conversation between a first user speaking a first natural language and second user speaking a second natural language;
capturing a second audio file from a second user speaking a second language into said input using said speech recognition software;
transmitting said second audio file to said language translation software;
translating said second audio file to a second language using said language translation software to provide a second audio file translation; and
returning said second audio file translation to said first user through said output of said translator device.

24. A method of enabling communication between a first user and a second user speaking different natural languages, comprising the steps of:
providing a apparatus having an input and an output;
providing speech recognition software, said speech recognition software being in communication with said apparatus;
providing language translation software in communication with said speech recognition software and said apparatus;
initiating a phone conversation between a first user speaking a first natural language and second user speaking a second natural language;
capturing a first audio file from a first user speaking a first language into said input using said speech recognition software, wherein said first audio file is not audible to said second user;
transmitting said first audio file to said language translation software;
translating said first audio file to a second language using said language translation software to provide a first audio file translation; and
returning said first audio file translation to said second user through said apparatus, said first audio file translation being audible to said first user and said second user.

25. The method of claim 24, further comprising the step of accepting a reading of said first audio file translation through said input device from said first user, said reading being audible to said second user.

26. A method as in claim 24, further comprising the step of converting said first audio file to text to provide a first text file and transmitting said first text file to said language translation software.

27. The method as in claim 24, further comprising the step of recording digital video from another device.

28. The method of claim 24, wherein said input is selected from a group consisting of microphone, keyboard, numeric text key pad, USB, television output or chat keyboard.

29. The method of claim 24, wherein said output is selected from the group consisting of a speaker, earphone and a screen.

30. The method as in claim 24, further comprising the steps of:
capturing a second audio file using said speech recognition software, wherein said second audio file is from a second user speaking a second language into an input and said second audio file is not audible to said first user;
transmitting said second audio file to said language translation software;
translating said second audio file to said first language using said language translation software to provide a second audio file translation; and
returning said second audio file translation to said second user through said output of said translator device such that said second audio file translation is only audible to said second user.

31. The method of claim 30, wherein said translator apparatus is a voice over internet protocol telephone device.

32. The method as in claim 30, wherein said apparatus is a mobile telephone.

33. The method as in claim 30, further comprising a text-based chatting utility.

34. The method as in claim 30, wherein said speech recognition software is installed remotely and in communication with said apparatus.

35. The method as in claim 30, wherein said language translation software is installed remotely and in communication with said apparatus.

36. An apparatus for translating a conversation between a first user and a second user speaking different natural languages, said apparatus comprising:
an input device for receiving an audio file from a first user speaking a first language;
a storage medium for storing speech recognition software and language translation software;
a CPU for processing language data from said input using said speech recognition software and said language translation software;
a communication interface for connecting to said speech recognition software and said language translation software; and
an output device for delivering audio files.

37. An apparatus as in claim 36, wherein said audio file is from a first user speaking a first language.

38. An apparatus as in claim 36, wherein said audio file is from a television.

39. An apparatus as in claim 36, further comprising a video camera, wherein said video camera is used to capture streaming video from said first user.

40. An apparatus as in claim 36, further comprising a USB output for connecting said apparatus to a computer.

41. An apparatus as in claim 36, wherein said input is selected from a group consisting of microphone, keyboard, numeric text key pad, USB, television output, video camera and chat keyboard.

42. An apparatus as in claim 36, further comprising a software application to be installed on a remote computer used for providing updates.

43. An apparatus as in claim 36, further comprising a headset with a microphone, speaker and earphone.

44. An apparatus as in claim 36, further comprising language selection input buttons as digital language drop down menus.

45. The apparatus of claim 36, further comprising a software application to be installed on a remote computer used for providing updates.

46. The apparatus as in claim 36, further comprising a telephone output, wherein said apparatus may be connected to a telephone jack.

47. The apparatus as in claim 36, further comprising an attachment means.

48. The apparatus as in claim 36, further comprising DVR software.

49. A pair of apparatus for translating a conversation between a first user and a second user speaking different natural languages, said apparatus comprising:
a first device comprising:
a microphone for receiving an audio file from a first user speaking a first language;
a storage medium for storing supporting applications, wherein said supporting applications translate said audio from a first user speaking a first language to a second language to provide a first translation;
a CPU for processing said language data;
a second device comprising:
an input device for receiving an audio file from a second user speaking a second language;
an output device for delivering said first translation to said second user;
a communication interface for connecting to remote computer applications, said remote computer application comprising speech recognition software and language translation software.

50. An apparatus as in claim 49, further comprising a video camera, wherein said video camera is used to capture streaming video from said first user.

51. An apparatus as in claim 49, further comprising a USB output for connecting said apparatus to a computer.

52. An apparatus as in claim 49, wherein said input is selected from a group consisting of microphone, keyboard, numeric text key pad, USB, television output, video camera and chat keyboard.

53. An apparatus as in claim 49, further comprising a software application to be installed on a remote computer used for providing updates.

54. An apparatus as in claim 49, further comprising a headset with a microphone, speaker and earphone.

55. An apparatus as in claim 49, further comprising language selection input buttons as digital language drop down menus.

56. An apparatus as in claim 49, further comprising an attachment means for attaching said first device to said first user or said second device to said second user.

57. The apparatus as in claim 49, further comprising DVR software.
